(19) United States
(12) Patent Application Publication
(10) Pub. No.: US 2022/0260364 A1
(43) Pub. Date: Aug. 18, 2022

(54) THREE-DIMENSIONAL SCANNING DEVICE AND METHOD

(71) Applicant: DOF INC., Seoul (KR)

(72) Inventors: Hyunsoo PARK, Seoul (KR); Heungsik SIM, Suwon-si, Gyeonggi-do (KR)

(73) Assignee: DOF INC., Seoul (KR)

(21) Appl. No.: 17/628,198

(22) PCT Filed: Jul. 29, 2020
(86) PCT No.: PCT/KR2020/010018

§ 371 Date: Jan. 18, 2022

(30) Foreign Application Priority Data
Jul. 29, 2019 (KR) 10-2019-0091479

(51) Int. Cl. G01B 11/24; G06T 7/00; G01S 7/481

(52) U.S. Cl. CPC G01B 11/24; G06T 2207/10028; G01S 7/4817; G06T 7/0004

(57) ABSTRACT

The present invention relates to a three-dimensional scanning device and method for scanning the shape of a subject by means of a three-dimensional scanner while rotating the subject and, more specifically, to a three-dimensional scanning device and method wherein scan data of a subject, acquired at arbitrary rotation angles of a turntable, can be automatically registered without user intervention and without a need to perform calibration according to the position of a three-dimensional scanner relative to the turntable.

### FIELD OF INVENTION

The present disclosure relates to a 3D scanning device and method for scanning a shape of a scan object using a 3D scanner while rotating the scan object, and more particularly to a 3D scanning device and method for automatically matching scan data of a scan object, obtained at respective arbitrary rotation angles of a turntable, without user intervention rather than separately performing calibration depending on a relative position between the turntable and a 3D scanner.

### BACKGROUND OF INVENTION

An operation of generating 3D scan data by scanning an object is called 3D scanning. The three-dimensional scanning is generally performed through a process of placing a scan object on a rotatable turntable, acquiring scan data at various angles using a three-dimensional scanner while rotating the turntable by 360°, and matching the obtained scan data.

In this case, the scan data acquired at various angles are defined in different coordinate systems, and thus in order to match these, the scan data defined in the different coordinate systems need to be aligned into one coordinate system, which means transformation between the different coordinate systems, and this relationship is represented by a position transformation matrix configured with three rotation parameters and three movement parameters.

A relative position between a turntable and a 3D scanner need to be defined in order to automatically match the scan data acquired at different angles without user intervention, and thus when the relative position between the turntable and the 3D scanner is changed, it is required to perform calibration in which a coordinate system of the turntable needs to be defined based on a coordinate system of the 3D scanner whenever the relative position between the turntable and the 3D scanner is changed.

FIG. 1 is a diagram showing an example of a conventional fixed 3D scanning device, and FIG. 2 is a diagram showing an example of a conventional variable 3D scanning device.

A fixed 3D scanning device 1 of FIG. 1 is formed in such a way that a relative position between a turntable 2 and a 3D scanner 3 is fixed, and once first calibration for the relative position between the turntable 2 and the 3D scanner 3 is performed, there is an advantage that there is no need to perform separate calibration thereafter, but the relative position between the turntable 2 and the 3D scanner 3 is fixed, and thus there are many limitations in the size of a scan object 4 to be scanned, a scan distance between the 3D scanner 3 and the scan object 4, and a scan direction.

A variable 3D scanning device 5 of FIG. 2 is formed in such a way that a relative position between the turntable 2 and the 3D scanner 3 is changed every scan rather than being fixed, and while it is advantageously possible to scan the scan object 4 in various directions and distances depending on the size or shape thereof, there is a disadvantage that separate calibration needs to be performed whenever the relative position between the turntable 2 and the 3D scanner 3 changes.

Conventionally, calibration between the turntable 2 and the 3D scanner 3 needs to be separately performed with various forms of markers being attached to the scan object 4, and thus there is a problem in that the calibration process is complicated and cumbersome, and it takes lots of time to perform calibration.

### SUMMARY OF INVENTION

### Technical Problem to be Solved

To overcome the above problems, the present disclosure may provide a 3D scanning device and method for automatically matching scan data of a scan object, obtained at respective arbitrary rotation angles of a turntable, without user intervention rather than separately performing calibration depending on a relative position between the turntable and a 3D scanner.

### Technical Solution

According to an embodiment of the present disclosure, a 3D scanning device includes a turntable with a scan object mounted thereon and configured to rotate the mounted scan object around a rotation axis, a 3D scanner configured to scan the scan object mounted on the turntable, and a controller configured to control the turntable and the 3D scanner to enable the 3D scanner to scan the scan object mounted on the turntable at each of arbitrary rotation angles of the turntable and configured to match scan data of the scan object, acquired at the respective arbitrary rotation angles of the turntable, wherein the controller includes a scan data acquirer configured to acquire reference scan data as scan data obtained by scanning the scan object mounted on the turntable by the 3D scanner in a state in which a rotation angle of the turntable is a reference angle, first scan data as scan data obtained by scanning the scan object mounted on the turntable by the 3D scanner in a state in which the rotation angle of the turntable is a first rotation angle θ₁, and second scan data as a plurality of scan data obtained by scanning the scan object mounted on the turntable at the respective arbitrary rotation angles of the turntable by the 3D scanner, from the 3D scanner, a first position transformation matrix derivation unit configured to derive a first position transformation matrix for matching the first scan data with the reference scan data using an iterative closest point (ICP) algorithm, a turntable rotation axis information derivation unit configured to derive information on the rotation axis of the turntable based on a coordinate system of the 3D scanner from the first position transformation matrix, a second position transformation matrix derivation unit configured to derive a second position transformation matrix for matching any one of the second scan data with the reference scan data using the information on the rotation axis of the turntable, and a second scan data matching unit configured to match the any one second scan data with the reference scan data using the second position transformation matrix.

According to an embodiment of the present disclosure, a 3D scanning method includes acquiring reference scan data as scan data obtained by scanning a scan object mounted on a turntable rotatable around a rotation axis by a 3D scanner in a state in which a rotation angle of the turntable is a reference angle, acquiring first scan data as scan data obtained by scanning the scan object mounted on the turntable by the 3D scanner in a state in which the rotation angle of the turntable is a first rotation angle θ₁, deriving a first position transformation matrix for matching the first scan data with the reference scan data using an iterative closest point (ICP) algorithm, deriving information on the rotation axis of the turntable based on a coordinate system of the 3D scanner from the first position transformation matrix, acquiring second scan data as a plurality of scan data obtained by scanning the scan object mounted on the turntable at the respective arbitrary rotation angles of the turntable by the 3D scanner, deriving a second position transformation matrix for matching any one of the second scan data with the reference scan data using the information on the rotation axis of the turntable, and matching the any one second scan data with the reference scan data using the second position transformation matrix.

### Effect of Invention

The 3D scanning device and method according to an embodiment of the present disclosure as configured above may automatically match scan data of a scan object, obtained at respective arbitrary rotation angles of a turntable, without user intervention rather than separately performing calibration depending on a relative position between the turntable and a 3D scanner.

It will be appreciated by persons skilled in the art that the effects that could be achieved with the present disclosure are not limited to what has been particularly described hereinabove and other advantages of the present disclosure will be more clearly understood from the above detailed description.

### BRIEF DESCRIPTION OF DRAWINGS

FIG. 1 is a diagram showing an example of a conventional fixed 3D scanning device,

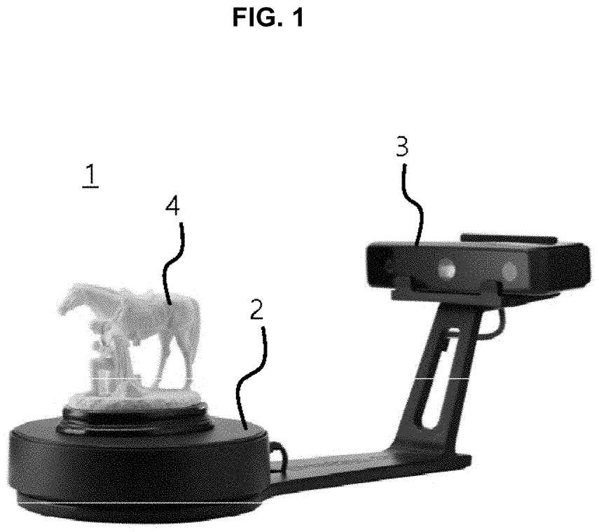

FIG. 2 is a diagram showing an example of a conventional variable 3D scanning device,

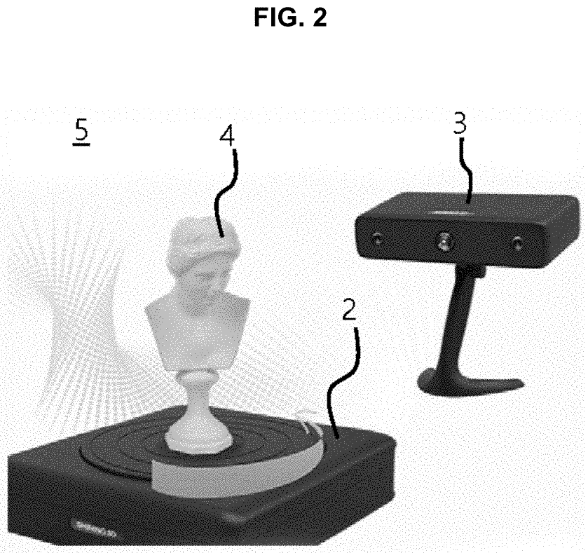

FIG. 3 is a schematic diagram showing a configuration of a 3D scanning device according to an embodiment of the present disclosure, and

FIG. 4 is a schematic flowchart of a 3D scanning method according to an embodiment of the present disclosure.

### BEST MODE

Hereinafter, the present disclosure will be described in detail. In the description with reference to the accompanying drawings, the same components are given the same reference numerals, and repeated description thereof will be omitted.

Terms such as first and second may be used to describe components, but the components are not limited to the above terms, and are used only for the purpose of distinguishing one component from other components.

When a part “includes” a certain component, it means that other components are further included, rather than excluding other components, unless otherwise stated.

In the drawings, the thickness or size of each layer (film), region, pattern or structure may be changed for clarity and convenience of description, and thus does not fully reflect the actual size.

In addition, each embodiment may be implemented independently or together, and some components may be excluded in accordance with the purpose of the present disclosure.

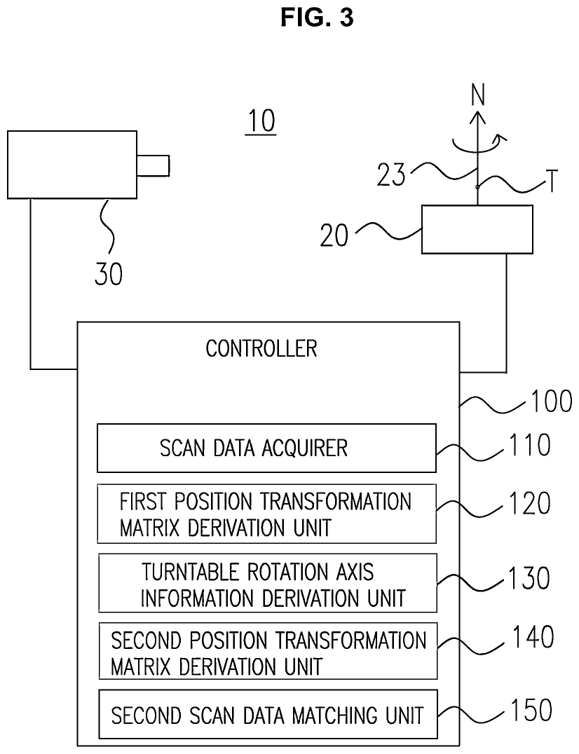

FIG. 3 is a schematic diagram showing a configuration of a 3D scanning device according to an embodiment of the present disclosure.

Referring to FIG. 3, a 3D scanning device 10 according to an embodiment of the present disclosure may include a turntable 20 on which a scan object is mounted, a 3D scanner 30 for scanning the scan object mounted on the turntable 20, and a controller 100 for controlling the turntable 20 and the 3D scanner 30.

The turntable 20 may be a component for rotating the mounted scan object around a rotation axis 23 and may be configured to rotate the mounted scan object by 360°.

The controller 100 may control the turntable 20 and the 3D scanner 30 to enable the 3D scanner 30 to scan the scan object mounted on the turntable 20 at each of arbitrary rotation angles.

For example, the controller 100 may control a rotation operation of the turntable 20 and a scan operation of the 3D scanner 30 to enable the 3D scanner 30 to scan the scan object mounted on the turntable 20 at a rotation angle of the turntable 20, for example, at 0° and 3°, every 5° and 10° as a larger rotation angle than 3°, or at each of arbitrarily selected rotation angles.

The controller 100 may automatically match scan data of the scan object, obtained at the respective arbitrary rotation angles of the turntable 20, without user intervention.

In particular, the controller 100 may be configured to automatically match the scan data of the scan object, obtained at the respective arbitrary rotation angles of the turntable 20, rather than separately performing calibration depending on the relative position between the turntable 20 and the 3D scanner 30.

To this end, the controller 100 may include a scan data acquirer 110, the first position transformation matrix derivation unit 120, a turntable rotation axis information derivation unit 130, a second position transformation matrix derivation unit 140, and a second scan data matching unit 150, which will be described below in detail.

The controller 100 may include a computing device including processors for performing a series of processes for scanning the scan object and may be implemented in the form of storing and executing a function program, code, and code segment for implementing the 3D scanning device 10 according to an embodiment of the present disclosure in a computer through a computer-readable recording medium.

The 3D scanner 30 may be fixed to a position spaced apart from the turntable 20 by a predetermined distance or may not be fixed.

That is, the 3D scanning device 10 according to an embodiment of the present disclosure may be a fixed 3D scanning device in which a relative position between the turntable 20 and the 3D scanner 30 is fixed or may be a variable 3D scanning device in which the relative position between the turntable 20 and the 3D scanner 30 is not fixed, and the present disclosure is not limited thereto.

However, the 3D scanning device 10 according to an embodiment of the present disclosure may automatically match scan data of the scan object, acquired at respective rotation angles of the turntable 20, rather than separately performing calibration depending on the relative position between the turntable 20 and the 3D scanner 30 and may be implemented as a variable 3D scanning device for scanning the scan object in various directions and distances depending on the size and shape thereof, and in this case, may also have an advantage of the fixed 3D scanning device that does not need to perform separate calibration whenever the relative position between the turntable 20 and the 3D scanner 30 is changed.

As described above, the controller 100 may include the scan data acquirer 110, the first position transformation matrix derivation unit 120, the turntable rotation axis information derivation unit 130, the second position transformation matrix derivation unit 140, and the second scan data matching unit 150.

The scan data acquirer 110 may acquire scan data (hereinafter referred to as “reference scan data”), which is obtained by scanning the scan object mounted on the turntable 20 by the 3D scanner 30, from the 3D scanner 30 in the state in which a rotation angle of the turntable 20 is a reference angle.

The reference angle may be defined as a rotation angle of the turntable 20, corresponding to an initial position of the turntable 20 when scan starts. For example, the reference angle may be 0°. However, the present disclosure is not limited thereto, and the reference angle may be any one angle within a rotation range of the turntable 20.

The scan data acquirer 110 may acquire scan data (hereinafter referred to as “first scan data”), which is obtained by scanning the scan object mounted on the turntable 20 by the 3D scanner 30, from the 3D scanner 30 in the state in which the rotation angle of the turntable 20 is a first rotation angle 91.

The first rotation angle 91 may be an angle for automatically matching the first scan data with the reference scan data using only an iterative closest point (ICP) algorithm without user intervention and may be any one angle within a range of about ±3° based on the reference angle. For example, when the reference angle is 0°, the first rotation angle θ₁ may be 1.5° that is any one angle within a range of about ±3°.

The scan data acquirer 110 may acquire a plurality of scan data (hereinafter referred to as “second scan data”), which are obtained by scanning the scan object mounted on the turntable 20 at the respective arbitrary rotation angles of the turntable 20 by the 3D scanner 30, from the 3D scanner 30.

For example, the second scan data may include the plurality of scan data obtained by performing scan every 5° within a range of 0° to 360° as a rotation angle of the turntable 20 by the 3D scanner 30 and may include 72 of total second scan data, may include the plurality of scan data obtained by performing scan every 10° and may include 36 of total second scan data, or may include the plurality of scan data acquired at a plurality of respective arbitrarily selected rotation angles, and the present disclosure is not limited to the number of the second scan data and the rotation angle of the turntable 20, at which the second scan data are each obtained.

The first position transformation matrix derivation unit 120 may derive a first position transformation matrix for matching the first scan data with the reference scan data using an iterative closest point (ICP) algorithm.

The first position transformation matrix may be defined as a rotation matrix R₁ and a translation matrix T₁ for rotating and moving the first scan data to match the first scan data with the reference scan data.

The turntable rotation axis information derivation unit 130 may derive information on the rotation axis 23 of the turntable 20 based on a coordinate system of the 3D scanner 30 from the first position transformation matrix.

The information on the rotation axis 23 of the turntable 20 may be defined by a point T on the rotation axis 23 and a direction vector N of the rotation axis 23 based on the coordinate system of the 3D scanner 30.

The second position transformation matrix derivation unit 140 may derive a second position transformation matrix for matching any one second scan data with the reference scan data using the information on the rotation axis 23 of the turntable 20.

The any one second scan data may be scan data obtained by scanning the scan object mounted on the turntable 20 by the 3D scanner 30 in the state in which the rotation angle of the turntable 20 is a second rotation angle θ₂.

The second position transformation matrix may be defined as a rotation matrix R₂ and a translation matrix T₂ for rotating and moving the any one second data to match the any one second scan data with the reference scan data.

The second scan data matching unit 150 may match the any one second scan data with the reference scan data using the second position transformation matrix.

Hereinafter, the turntable rotation axis information derivation unit 130 will be described in detail.

The turntable rotation axis information derivation unit 130 may derive the information on the rotation axis 23 of the turntable 20 using a formula representing the first position transformation matrix and rotation matrix based on a rotation vector and an angle.

The formula representing the rotation matrix based on a rotation vector and an angle may use an expression, for example, Quaternion, Rodrigues' rotation formula, or an angle-axis formula.

The ICP algorithm may be a general method for matching two 3D cloud data, and when the ICP algorithm is used, a first position transformation matrix for matching the first scan data with the reference scan data may be derived.

The ICP algorithm may be used to calculate a rotation matrix and a translation matrix of Rigid Body Motion for minimizing a total distance between points present in two 3D cloud data, the first position transformation matrix acquired through the ICP algorithm may be defined based on the rotation matrix R₁ and the translation matrix T₁ and may be represented as follows based on a homogeneous matrix (4×4 matrix).

$${M}_{1} = {[ {\begin{matrix}\begin{matrix}{r}_{11} & {r}_{12} & {r}_{13} \\ {r}_{21} & {r}_{22} & {r}_{23} \\ {r}_{31} & {r}_{32} & {r}_{33}\end{matrix} & \begin{matrix}\begin{matrix}{r}_{14} \\ {r}_{24}\end{matrix} \\ {r}_{34}\end{matrix} \\ \begin{matrix}\begin{matrix}0 & 0\end{matrix} & 0\end{matrix} & 1\end{matrix}}^{\begin{matrix}↓ & ↓\end{matrix}} ]}^{\begin{matrix}{R}_{1} & {T}_{1}\end{matrix}} \qquad 〈 Formula 1 〉$$

Here, M₁ is a homogeneous matrix of the first position transformation matrix, R₁ is a rotation matrix of the first position transformation matrix, and T₁ is a translation matrix of the first position transformation matrix.

The first position transformation matrix may be defined by moving the rotation axis 23 of the turntable 20 by −T to pass the origin of a coordinate system of the 3D scanner 30 (since T is one point on the rotation axis 23 based on the coordinate system of the 3D scanner 30, when the rotation axis 23 is moved by −T, the rotation axis 23 passes the origin of the coordinate system of the 3D scanner 30, and in this case, one point on the first scan data is also moved by −T along with the rotation axis 23), rotating one point on the first scan data around the rotation axis 23 by (−)first rotation angle −θ₁, and moving the rotation axis 23 again to the original position by T (Then, one point on the first scan data may be matched with the reference scan data), and may be represented as follows based on a homogeneous matrix (4×4 matrix).

$$〈 Formula 2 〉 \\ {M}_{1} = ( {M}_{T} ) ( {M}_{R} ) ( {M}_{( - T )} ) = [ \begin{matrix}I & T \\ 0 & 1\end{matrix} ] [ \begin{matrix}R & 0 \\ 0 & 1\end{matrix} ] [ \begin{matrix}I & - T \\ 0 & 1\end{matrix} ] = [ \begin{matrix}R & T ( R - I ) \\ 0 & 1\end{matrix} ]$$

Here, M₁ is a homogeneous matrix of the first position transformation matrix, T is one point on the rotation axis 23 of the turntable 20 based on the coordinate system of the 3D scanner 30, R is a rotation matrix for rotating one point on the first scan data by (−) first rotation angle −θ₁ around the rotation axis 23, M_{(-T)} is a homogeneous matrix for moving the rotation axis 23 by −T, M_{R} is a homogeneous matrix for rotating one point on the first scan data by (−) first rotation angle −θ₁ around the rotation axis 23, and M_{T} is a homogeneous matrix for moving the rotation axis 23 by T.

When <Formula 1> and <Formula 2> are used, <Formula 3> below may be derived.

R₁=R, T₁=T(R−I) <Formula 3>

Thus, the turntable rotation axis information derivation unit 130 may derive the point T on the rotation axis 23 of the turntable 20 from the information on the rotation axis 23 of the turntable 20 using the following formula.

T₁=T(R₁−I)

Here, R₁ is a rotation matrix of the first position transformation matrix, T₁ is a translation matrix of the first position transformation matrix, and I is a unit matrix.

The turntable rotation axis information derivation unit 130 may derive the direction vector N of the rotation axis 23 as another one of the information on the rotation axis 23 of the turntable 20 using a formula representing a rotation matrix based on a rotation vector and an angle.

For example, the turntable rotation axis information derivation unit 130 may derive <Formula 4> below using one of a formula representing the rotation matrix R (which is a rotation matrix for rotating one point on the first scan data by (−) first rotation angle −θ₁ around the rotation axis 23) based on a rotation vector and an angle, for example, an angle-axis formula, and may derive the direction vector N of the rotation axis 23 using <Formula 3> and <Formula 4>.

R=I+(sin θ₁)N+(1−cos θ₁)N² <Formula 4>

That is, the turntable rotation axis information derivation unit 130 may derive the direction vector N of the rotation axis 23 using the following formula.

R₁=I+(sin θ₁)N+(1−cos θ₁)N²

Here, R₁ is a rotation matrix of the first position transformation matrix, θ₁ is the first rotation angle, and I is a unit matrix.

Here, the second position transformation matrix derivation unit 140 will be described in detail.

The second position transformation matrix derivation unit 140 may derive the second position transformation matrix using the information on the rotation axis 23 of the turntable 20 and a formula representing a rotation matrix based on a rotation vector and an angle.

The formula representing the rotation matrix based on a rotation vector and an angle may be Quaternion, Rodrigues' rotation formula, or an angle-axis formula.

The second position transformation matrix may be defined by a rotation matrix R₂ and a translation matrix T₂ like the first position transformation matrix and may be represented below by a homogeneous matrix (4×4 matrix).

$$〈 Formula 5 〉 \\ {M}_{2} = {[ {\begin{matrix}\begin{matrix}{r}_{11} & {r}_{12} & {r}_{13} \\ {r}_{21} & {r}_{22} & {r}_{23} \\ {r}_{31} & {r}_{32} & {r}_{33}\end{matrix} & \begin{matrix}\begin{matrix}{r}_{14} \\ {r}_{24}\end{matrix} \\ {r}_{34}\end{matrix} \\ \begin{matrix}\begin{matrix}0 & 0\end{matrix} & 0\end{matrix} & 1\end{matrix}}^{\begin{matrix}↓ & ↓\end{matrix}} ]}^{\begin{matrix}{R}_{2} & {T}_{2}\end{matrix}} = ( {M}_{T} ) ( {M}_{{R}^{′}} ) ( {M}_{( - T )} ) = [ \begin{matrix}{R}^{′} & T ( {R}^{′} - I ) \\ 0 & 1\end{matrix} ]$$

Here, M₂ is a homogeneous matrix of the second position transformation matrix, R₂ is a rotation matrix of the second position transformation matrix, T₂ is a translation matrix of the second position transformation matrix, T is one point on the rotation axis 23 of the turntable 20 based on the coordinate system of the 3D scanner 30, R′ is a rotation matrix for rotating one point on the second scan data by (−) second rotation angle −θ₂ around the rotation axis 23 of the turntable 20, M_{(-T)} is a homogeneous matrix for moving the rotation axis 23 by −T, M_{R′} is a homogeneous matrix for rotating one point on the second scan data by (−) second rotation angle −θ₂ around the rotation axis 23 of the turntable 20, and M_{T} is a homogeneous matrix for moving the rotation axis 23 by T.

Then, <Formula 6> below may be derived from <Formula 5>.

R₂=R′, T₂=T(R′−I)=T(R₂−I) <Formula 6>

Here, R₂ is a rotation matrix of the second position transformation matrix, and T₂ is a translation matrix of the second position transformation matrix.

Thus, the second position transformation matrix derivation unit 140 may derive the rotation matrix R₂ of the second position transformation matrix using the information on the rotation axis 23 of the turntable 20 and a formula representing a rotation matrix based on a rotation vector and an angle.

For example, the second position transformation matrix derivation unit 140 may derive <Formula 7> below using one of a formula representing the rotation matrix R′ (which is a rotation matrix for rotating one point on the second scan data by (−) second rotation angle −θ₂ around the rotation axis 23) based on a rotation vector and an angle, for example, an angle-axis formula, and may derive the rotation matrix R₂ of the second position transformation matrix using <Formula 6> and <Formula 7>.

R′=I+(sin θ₂)N+(1−cos θ₂)N² <Formula 7 >

That is, the second position transformation matrix derivation unit 140 may derive the rotation matrix R₂ of the second position transformation matrix using the following formula.

R₂=I+(sin θ₂)N+(1−cos θ₂)N²

Here, N is a direction vector of the rotation axis 23, θ₂ is a second rotation angle that is a rotation angle of the turntable 20, at which the any one second scan data is acquired, and I is a unit matrix.

The second position transformation matrix derivation unit 140 may derive the translation matrix T₂ of the second position transformation matrix using the following formula.

T₂=T(R₂−I)

Here, T is one point on the rotation axis 23 of the turntable 20, R₂ is a rotation matrix of the second position transformation matrix, and I is a unit matrix.

Hereinafter, a 3D scanning method according to an embodiment of the present disclosure will be described in detail.

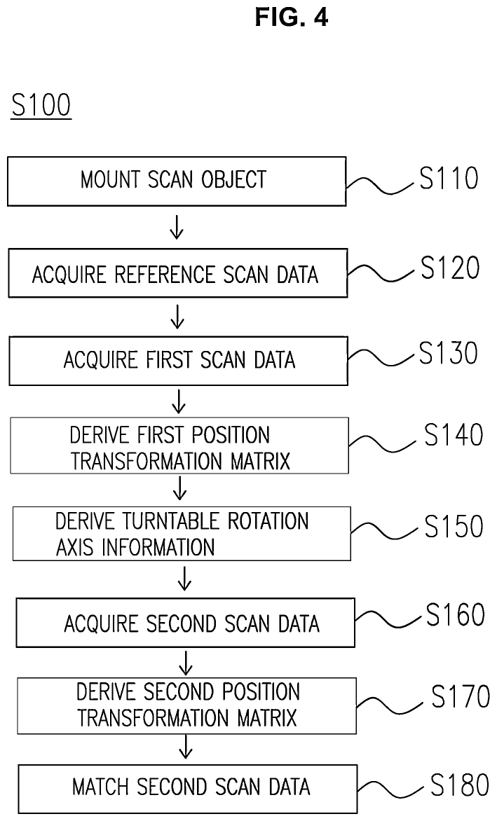

FIG. 4 is a schematic flowchart of a 3D scanning method according to an embodiment of the present disclosure.

Referring to FIG. 4, a 3D scanning method S100 according to an embodiment of the present disclosure may include a scan object mounting operation S110, a reference scan data acquiring operation S120, a first scan data acquiring operation S130, a first position transformation matrix deriving operation S140, a turntable rotation axis information deriving operation S150, a second scan data acquiring operation S160, a second position transformation matrix deriving operation S170, and a second scan data matching operation S180.

The scan object mounting operation S110 may be an operation of mounting the scan object on the turntable 20 that is rotatable around the rotation axis 23.

The reference scan data acquiring operation S120 may be an operation of acquiring reference scan data that is scan data obtained by scanning the scan object mounted on the turntable 20 by the 3D scanner 30 in the state in which the rotation angle of the turntable 20 is the reference angle.

The first scan data acquiring operation S130 may be an operation of acquiring the first scan data that is scan data obtained by scanning the scan object mounted on the turntable 20 by the 3D scanner 30 in the state in which the rotation angle of the turntable 20 is the first rotation angle θ₁.

The first position transformation matrix deriving operation S140 may be an operation of deriving a first position transformation matrix for matching the first scan data with the reference scan data using an iterative closet point (ICP) algorithm.

In this case, in the first position transformation matrix deriving operation S140, the first position transformation matrix for matching the first scan data with the reference scan data and simultaneously matching the first scan data with the reference scan data using an iterative closest point (ICP) algorithm.

The turntable rotation axis information deriving operation S150 may be an operation of deriving information on the turntable 20 based on a coordinate system of the 3D scanner 30 from the first position transformation matrix.

In the turntable rotation axis information deriving operation S150, the information on the rotation axis of the turntable may be derived using a formula representing the first position transformation matrix and the rotation matrix based on a rotation vector and an angle.

The formula representing the rotation matrix based on a rotation vector and an angle may use an expression, for example, Quaternion, Rodrigues' rotation formula, or an angle-axis formula.

In the turntable rotation axis information deriving operation S150, the point T on the rotation axis 23 of the turntable 20 may be derived using the following formula.

T₁=T(R₁−I)

Here, R₁ is a rotation matrix of the first position transformation matrix, T₁ is a translation matrix of the first position transformation matrix, and I is a unit matrix.

In the turntable rotation axis information deriving operation S150, the direction vector N of the rotation axis may be derived using the formula representing the rotation matrix based on a rotation vector and an angle.

For example, in the turntable rotation axis information deriving operation S150, the direction vector N of the rotation axis may be derived using the following formula.

R₁=I+(sin θ₁)N+(1−cos θ₁)N²

Here, R₁ is a rotation matrix of the first position transformation matrix, θ₁ is the first rotation angle, and I is a unit matrix.

The second scan data acquiring operation S160 may be an operation of acquiring the second scan data as a plurality of scan data obtained by scanning the scan object mounted on the turntable 20 at the respective arbitrary rotation angles of the turntable 20 by the 3D scanner 30.

The second position transformation matrix deriving operation S170 may be an operation of deriving a second position transformation matrix for matching any one second scan data with the reference scan data using the information on the rotation axis 23 of the turntable 20.

The any one second scan data may be scan data obtained by scanning the scan object mounted on the turntable 20 by the 3D scanner 30 in the state in which the rotation angle of the turntable 20 is a second rotation angle θ₂.

In the second position transformation matrix deriving operation S170, the second position transformation matrix may be derived using the information on the rotation axis 23 of the turntable 20 and the formula representing the rotation matrix based on a rotation vector and an angle.

The formula representing the rotation matrix based on a rotation vector and an angle may use an expression, for example, Quaternion, Rodrigues' rotation formula, or an angle-axis formula.

The second position transformation matrix may be defined by a rotation matrix R₂ and a translation matrix T₂ like the first position transformation matrix.

In the second position transformation matrix deriving operation S170, the second position transformation matrix R₂ may be derived using the information on the rotation axis 23 of the turntable 20 and the formula representing the rotation matrix based on a rotation vector and an angle.

For example, in the second position transformation matrix deriving operation S170, the rotation matrix R₂ of the second position transformation matrix may be derived using the following formula.

R₂=I+(sin θ₂)N+(1−cos θ₂)N²

Here, N is a direction vector of the rotation axis 23, θ₂ is a second rotation angle that is a rotation angle of the turntable 20, at which the any one second scan data is acquired, and I is a unit matrix.

In the second position transformation matrix deriving operation S170, the translation matrix T₂ of the second position transformation matrix may be derived using a following formula.

T₂=T(R₂−I)

Here, T is one point on the rotation axis 23 of the turntable 20, R₂ is a rotation matrix of the second position transformation matrix, and I is a unit matrix.

The second scan data matching operation S180 may be an operation of matching the any one second scan data with the reference scan data using the second position transformation matrix.

As described above, the present disclosure relates to a 3D scanning device and method for automatically matching scan data of a scan object, acquired at the respective arbitrary rotation angles of a turntable, without user intervention rather than performing separate calibration depending on a relative position between a turntable and a 3D scanner, and embodiments of the present disclosure may be changed in various forms. Accordingly, the present disclosure is not limited by the embodiments disclosed herein, and all forms that can be changed by one of ordinary skill in the art to which the present disclosure pertains will fall within the scope of the present disclosure.

1. A 3D scanning device comprising:
a turntable with a scan object mounted thereon and configured to rotate the mounted scan object around a rotation axis;
a 3D scanner configured to scan the scan object mounted on the turntable; and
a controller configured to control the turntable and the 3D scanner to enable the 3D scanner to scan the scan object mounted on the turntable at each of arbitrary rotation angles of the turntable and configured to match scan data of the scan object, acquired at the respective arbitrary rotation angles of the turntable,
wherein the controller includes:
a scan data acquirer configured to acquire reference scan data as scan data obtained by scanning the scan object mounted on the turntable by the 3D scanner in a state in which a rotation angle of the turntable is a reference angle, first scan data as scan data obtained by scanning the scan object mounted on the turntable by the 3D scanner in a state in which the rotation angle of the turntable is a first rotation angle θ₁, and second scan data as a plurality of scan data obtained by scanning the scan object mounted on the turntable at the respective arbitrary rotation angles of the turntable by the 3D scanner, from the 3D scanner;
a first position transformation matrix derivation unit configured to derive a first position transformation matrix for matching the first scan data with the reference scan data using an iterative closest point (ICP) algorithm;
a turntable rotation axis information derivation unit configured to derive information on the rotation axis of the turntable based on a coordinate system of the 3D scanner from the first position transformation matrix;
a second position transformation matrix derivation unit configured to derive a second position transformation matrix for matching any one of the second scan data with the reference scan data using the information on the rotation axis of the turntable; and
a second scan data matching unit configured to match the any one second scan data with the reference scan data using the second position transformation matrix.

2. The 3D scanning device of claim 1, wherein the turntable rotation axis information derivation unit derives the information on the rotation axis of the turntable using a formula representing the first position transformation matrix and a rotation matrix based on a rotation vector and an angle.

3. The 3D scanning device of claim 2, wherein the first position transformation matrix is defined by a rotation matrix R₁ and a translation matrix T₁,
the information on the rotation axis of the turntable is defined by a point T on the rotation axis of the turntable and a direction vector N of the rotation axis based on the coordinate system of the 3D scanner,
the turntable rotation axis information derivation unit derives the point T on the rotation axis of the turntable using a following formula
T₁=T(R₁−I)
(where R₁ is the rotation matrix of the first position transformation matrix, T₁ is a translation matrix of the first position transformation matrix, and I is a unit matrix), and derives the direction vector N of the rotation axis using a formula representing the rotation matrix as a rotation vector and an angle.

4. The 3D scanning device of claim 3, wherein the turntable rotation axis information derivation unit derives the direction vector N of the rotation axis using a following formula
R₁=I+(sin θ₁)N+(1−cos θ₁)N²
(where R₁ is the rotation matrix of the first position transformation matrix, θ₁ is a first rotation angle, and I is a unit matrix).

5. The 3D scanning device of claim 1, wherein the second position transformation matrix derivation unit derives the second position transformation matrix using a formula representing the information on the rotation axis of the turntable and a rotation matrix based on a rotation vector and an angle.

6. The 3D scanning device of claim 5, wherein the information on the rotation axis of the turntable is defined by a point T on the rotation axis of the turntable and a direction vector N of the rotation axis based on the coordinate system of the 3D scanner, and the second position transformation matrix is defined by the rotation matrix R₂ and a translation matrix T₂, and
The second position transformation matrix derivation unit derives the rotation matrix R₂ of the second position transformation matrix using the information on the rotation axis of the turntable and a formula representing a rotation matrix based on a rotation vector and an angle, and derives the translation matrix T₂ of the second position transformation matrix using a following formula:
T₂=T(R₂−I)
(where T is a point on the rotation axis of the turntable and I is a unit matrix).

7. The 3D scanning device of claim 6, wherein the second position transformation matrix derivation unit derives a rotation matrix R₂ of the second position transformation matrix using a following formula:
R₂=I+(sin θ₂)N+(1−cos θ₂)N²
(where N is a direction vector of the rotation axis, θ₂ is a second rotation angle as the rotation angle of the turntable, at which the any one second scan data is acquired, and I is a unit matrix).

8. A 3D scanning method comprising:
acquiring reference scan data as scan data obtained by scanning a scan object mounted on a turntable rotatable around a rotation axis by a 3D scanner in a state in which a rotation angle of the turntable is a reference angle;
acquiring first scan data as scan data obtained by scanning the scan object mounted on the turntable by the 3D scanner in a state in which the rotation angle of the turntable is a first rotation angle θ₁;
deriving a first position transformation matrix for matching the first scan data with the reference scan data using an iterative closest point (ICP) algorithm;
deriving information on the rotation axis of the turntable based on a coordinate system of the 3D scanner from the first position transformation matrix;
acquiring second scan data as a plurality of scan data obtained by scanning the scan object mounted on the turntable at the respective arbitrary rotation angles of the turntable by the 3D scanner;
deriving a second position transformation matrix for matching any one of the second scan data with the reference scan data using the information on the rotation axis of the turntable; and
matching the any one second scan data with the reference scan data using the second position transformation matrix.

9. The method of claim 8, wherein the deriving the information on the rotation axis of the turntable includes deriving the information on the rotation axis of the turntable using a formula representing the first position transformation matrix and a rotation matrix based on a rotation vector and an angle.

10. The method of claim 9, wherein the first position transformation matrix is defined by a rotation matrix R₁ and a translation matrix T₁,
the information on the rotation axis of the turntable is defined by a point T on the rotation axis of the turntable and a direction vector N of the rotation axis based on the coordinate system of the 3D scanner,
the deriving the information on the rotation axis of the turntable includes:
deriving the point T on the rotation axis of the turntable using a following formula
T₁=T(R₁−I)
(where R₁ is the rotation matrix of the first position transformation matrix, T₁ is a translation matrix of the first position transformation matrix, and I is a unit matrix); and
Deriving the direction vector N of the rotation axis using a formula representing the rotation matrix as a rotation vector and an angle.

11. The method of claim 10, wherein the deriving the information on the rotation axis of the turntable includes deriving
the direction vector N of the rotation axis using a following formula
R₁=I+(sin θ₁)N+(1−cos θ₁)N²
(where R₁ is the rotation matrix of the first position transformation matrix, θ₁ is a first rotation angle, and I is a unit matrix).

12. The method of claim 8, wherein the deriving the second position transformation matrix includes deriving the second position transformation matrix using a formula representing the information on the rotation axis of the turntable and a rotation matrix based on a rotation vector and an angle.

13. The method of claim 12, wherein the information on the rotation axis of the turntable is defined by a point T on the rotation axis of the turntable and a direction vector N of the rotation axis based on the coordinate system of the 3D scanner, and the second position transformation matrix is defined by the rotation matrix R₂ and a translation matrix T₂, and
the deriving the second position transformation matrix includes:
deriving the rotation matrix R₂ of the second position transformation matrix using the information on the rotation axis of the turntable and a formula representing a rotation matrix based on a rotation vector and an angle; and
deriving the translation matrix T₂ of the second position transformation matrix using a following formula:
T₂=T(R₂−I)
(where T is a point on the rotation axis of the turntable and I is a unit matrix).

14. The method of claim 13, wherein the deriving the second position transformation matrix includes deriving a rotation matrix R₂ of the second position transformation matrix using a following formula:
R₂=I+(sin θ₂)N+(1−cos θ₂)N²
(where N is a direction vector of the rotation axis, θ₂ is a second rotation angle as the rotation angle of the turntable, at which the any one second scan data is acquired, and I is a unit matrix).
